(19) United States
(12) Patent Application Publication
(10) Pub. No.: US 2002/0052818 A1
(43) Pub. Date: May 2, 2002

(54) Method and system for acquiring equity from the purchase of goods & services incorporating a method and system for purchase of goods & services leveraged by portfolio held investments

(76) Inventor: Andrew J. Loveland, Twickenham (GB)

Correspondence Address: Arthur L. Plevy, Duane, Morris & Heckscher LLP, Suite 100, 100 College Road West, Princeton, NJ, 08540, US

(21) Appl. No.: 09/881,619

(22) Filed: Jun. 14, 2001

Related U.S. Application Data
(60) Provisional application No. 60/211,499, filed on Jun. 14, 2000.

(51) Int. Cl. G06F 17/60

(52) U.S. Cl. 705/36

(57) ABSTRACT

A method of providing a consumer of products with equity in the ultimate provider of said products, either online or offline is provided. The consumer is provided with the ability of purchasing products directly and automatically against margin accounts, credit accounts collateralized by portfolio held investments. The consumer optionally receives a reward for the purchase in the form of equity, which includes options or share in a mutual fund. The consumer is also provided with the option of adding incremental amounts to the value of a purchase to acquire additional investments in the provider of the product.

### RELATED APPLICATION DATA

Priority is hereby claimed from Provisional Application Ser. No. 60/211,499, filed Jun. 14, 2000, the disclosure of which is hereby incorporated.

### BACKGROUND OF THE INVENTION

1. Field of Invention

The present invention relates generally to the selling of goods and services and the online provision brokerage services over a large computer network. In particular the invention relates to a method of automatically rewarding purchases of goods and services with equity or equity options in the ultimate producer or provider of those goods or services being purchased, a method of acquiring equity in the producer or provider of the goods and services being purchased at the time of purchasing the goods or services, and the purchase of products and services directly using credit collateralized by portfolio held investment assets. The invention incorporates transactions from retailers of goods and services, all Sales Intermediaries (such as online portal Yahoo!), and transactions directly from the manufacturers of products and providers of services. The invention includes equity or equity option rewards funded by the manufacturer or service provider, retailers of the goods and services and Sales Intermediaries whether independently or collectively by these merchants. The invention includes the selling of goods and services whether through a company apart of the global interconnection of computers and computer networks (‘online’) or not.

2. Description of Related Art

Business to consumer commerce is continuing to grow despite evidence that the economy may be slowing. For example, in the midst of dying Internet companies and a bearish stock market, consumers continue to shop online. However in contrast to the strength shown in the demand for consumer purchasing, those operating sales activities in the sector are struggling to propel themselves to lasting success. This is particularly prevalent amongst companies selling goods and services online.

Companies have to differentiate themselves and their products from the plethora of competitors. Customer loyalty measured in repeat purchases and referrals is the key driver of profitability for such business according to a series of joint studies by Bain & Company and Mainspring. Survey data provided by Shop.org and the Boston Consulting Group (BCG) advocates a focus on providing a more rewarding shopping experience to both new and repeat customers. Under any competitive conditions maximizing customer attention, retention and long term value is a key strategy in increasing profitability.

Producers of products and providers of services use retailers or Sales Intermediaries (such as online portals) to promote the sale of their goods and/or services as well as promoting the sale of their goods and/or services directly themselves. Whether the sale is conducted by the manufacturer/service provider, retailers or Sales Intermediaries the price at which the product is sold incorporates a ‘margin’ for the merchant selling the products, the difference between the cost of the goods/services and the sale price. From this margin the merchant is expected to cover the cost of promoting and fulfilling the sale of the goods or services.

Consumers purchasing goods and services do so having recognized merit in the producer or provider of the goods/service or their offerings. In making the purchase the consumer is contributing to the future success of that company.

No known company, including retailers, Sales Intermediary or direct producers of goods/providers of services presently rewards these consumer purchases with a portion of the transaction value in the form of real equity or equity options in the manufacturer or service provider from whom the products or services are ultimately purchased. Nor does any known company provide a consumer purchasing products or services with the ability to purchase equity investments in the supplier whose products or services they are ultimately purchasing, and in whom they recognize merit, at the same time.

Accordingly, there is the need for the retailers, Sales Intermediaries and producers of goods/providers of services to successfully reward its customers such that they can maximize customer attention and retention, and in so doing, increasing the long-term value of their customers and differentiating themselves from their competition. There is also the need for consumer purchases to be recognized as investments that contribute to the future of the manufacturers and providers and for these investments to be automatically rewarded with equity or equity options. There is also the need to provide consumers with the ability to purchase additional equity in the manufacturer of goods and provider of services when they are purchasing the goods or services of companies in which they recognize merit.

Online brokerages make money primarily through commission and interest revenues. The number of active clients an online brokerage has and the value of the assets it manages are of primary importance. Where a brokerage can maximize the number of clients it has and the asset value of its clients it is able to maximize commission and interest revenues.

Commission revenues are generated when a customer executes a trade. While the Internet has driven down the cost of performing the trade, through direct access to exchanges and minimal human interaction, the minimum commissions charged still make the purchase of shares in lower value/volume economically unsound without significant positive price movement expected in the share price. The brokerages also require consumers to deposit significant funds with the brokerage in order to open the account in the first place.

The interest revenue earned by the brokerage is through ‘margin interest’. A client is able to borrow from the brokerage funds against assets already held with the brokerage to purchase more stock. For this service the brokerage collects an interest charge against the borrowed funds. This is a highly attractive revenue stream as it not only increases the transaction volume but also all margin loans are collateralized with securities already in the customer's account. The debt-to-value ratio of a customer's account can be easily monitored in real time and the brokerages have the right to liquidate an account if the value of the collateral falls below a certain point. Margin accounts are very highly secured loans and therefore the loan loss provisions on them tend to be extremely low and rarely needed.

The advantage to the investor is that he or she can increase their investment purchasing power and exposure to potential profit while maintaining positions in other stocks they consider favorable. They are also able to borrow at extremely low rates and gain tax efficiency.

Many people who hold collateral online by way of brokerage held investments are able to use it to source low cost margin loans in order to purchase further financial investments. However this collateral cannot currently be used as leverage to source low cost debt to seamlessly purchase any goods or services. There is no known company with the methodology to provide a service whereby purchases of goods and services can be funded directly using margin loans and for it to be as easy as purchasing using a bank or credit card. Brokerages are in the business of dealing in financial instruments and are not Sales Intermediaries. Merchants are in the business of selling goods and services and do not hold consumer's assets against which margin loans can be made.

Accordingly there is a need for a transaction process that enables consumers to use low cost debt leveraged by portfolio held investments to purchase goods and services from a merchant and to do so directly and seamlessly. Furthermore, there is a need to provide a Sales Intermediary whereby retailers, producers of goods/providers of services and Sales Intermediaries are linked with brokerages such that consumers are provided with the ability to purchase consumer goods and services from a plurality of merchants directly and seamlessly against their portfolio held collateral.

There is also the need to provide brokerages with an increased number of consumers with active accounts and greater asset value within. There is a need for a mechanism that can empower and educate more consumers with share ownership and generate more active brokerage accounts. There is a need to provide a method of enabling consumers to acquire investments more easily and more cost effectively particularly to enable viable small infrequent purchases.

### SUMMARY OF THE INVENTION

Briefly described, the invention comprises a method of promoting the sales of goods and services (‘Products’) online and offline and a method of providing consumer acquisition of equity investments and brokerage services, particularly online brokerage services.

The invention includes a method and system for acquiring equity investments from the purchase of Products. When a consumer purchases the Products of a manufacturer or service provider (‘Supplier’) from any merchant they automatically receive an equity reward for every purchase, regardless of reward size, even if the consumer reward requires fractional shares in that manufacturer or service provider. The equity reward will typically be ordinary shares of stock, but may also be in the form of equity options. In either case the equity reward is a real investment in the manufacturer or service provider of the goods or services that have been purchased, and not in the retailer or Sales Intermediary reselling the Products. To clarify, if a consumer purchases a SONY TV from any merchant they will receive SONY equity or equity options;

likewise purchasing a Compaq PC would be rewarded with Compaq equity or equity options. Each consumer rewarded with equity for their purchases will have an online account setup, into which all equity rewards are accumulated and from which they can be managed. In the mechanics of the present invention, and as illustrated in the Figures, are a suite of unique broker dealer services that provide education and accommodate and encourage further retail investment activity. Included in which is a mechanism whereby consumers can sell cost effectively any equity holdings they may have, regardless of how small and whether these holdings are in whole shares or fractions.

The invention provides the ability for the consumer purchasing a Product to add to the value of the equity award at the time of the transaction to purchase further equity or equity options in the providers of the Product. The additional sums are added to the equity award value and can be of any monetary value. For example, when purchasing a SONY TV for $1000 dollars, the consumer may receive a SONY equity reward of $100 and choose to pay an extra $100 ($1100 in total) in order to receive $200 dollars of SONY equity.

The present invention also provides consumers with the ability to purchase Products and pay for the transaction directly from margin facilities they have with their brokerage. Consumers are able to purchase Products from a merchant against margin accounts in a similar way as they would with a credit or bank card. The advantage is that as the margin loans are highly secured by the greater assets in the brokerages the brokerage is able offer a low interest debt to the consumer, far less than other sources of credit such as credit cards. These loans may also prove tax efficient for the consumer.

Accordingly, the method includes automatically providing a consumer with equity in the Suppliers of whose Products they purchase whether the promotion and sale of the Products is conducted by a retailer, Sales Intermediaries such as online portals, and by the Supplier directly (collectively referred to as Merchants who provide goods and/or services. The method operates with or without the use of the global interconnection of computers and computer networks, commonly known as the Internet.

Where any Merchant is promoting the sale of Products, the method includes the steps of determining the Products that they wish to promote the sale of with an equity incentive, determining a value of the Product sale that is to be given back to the customer in the form of an equity/equity option reward either independently of the Suppliers where the Merchant is not also the Supplier or in corroboration, promoting the Products for sale, advertising the portion of the transaction value that will fund the equity or equity options reward, allowing the consumer to add any increment of money to the transaction at the time of Product purchase in order to add to the equity/equity option reward and therefore acquire more equity in the Supplier, checking the debit or credit accounts of the consumer at the time of purchase and deducting the amount of the committed transaction from the customer's available balance or credit facility where a company implementing the method of the invention is responsible for the Product purchase transaction, processing the transaction, providing the consumer with a brokerage account after purchasing Products (either directly or using a third party company) into which the rewards will be ultimately placed, retaining the portion of the transaction that will fund the equity or equity option reward and any additional money added by the customer, placing these funds in the customers brokerage account for a period of time covering the ‘returns period’ applicable to the Product purchased, accumulating batches of the customer reward funds according to the specific Supplier where there is more than one providing equity rewards, enabling the consumer to access their account during the returns period, enabling the customer to choose to add sums to the reward in order to purchase further equity and to choose whether equity or equity options are the preferred form of the reward, waiting for the returns period to pass, acquiring the equity or equity options rewards in each Supplier in batches where the Supplier is a publicly quoted company (so as to minimize the number of transactions required to acquire the rewards), or placing the reward funds into a mutual fund in return for a representative share of the fund where the Supplier is not a publicly quoted company, purchasing equity in each of the publicly quoted Suppliers whose Products are sold to make up the equity holdings of the mutual fund, netting off any demand for shares with customers selling equity in the same Supplier when acquiring the equity or alternatively acquiring the equity directly from the Supplier or from the appropriate exchange.

The method also includes the of step of providing the consumer with the option of selling investments, again in cost effective batches unless otherwise requested, where the Company charges a fee for the transaction.

In an alternate preferred embodiment, the method also includes enabling a consumer wishing to purchase Products to do so directly using low credit interest ‘margin accounts’, and includes making purchases directly from a Supplier or Retailer through the Internet. Alternatively, a credit card or other similar means is employed by which purchases against margin accounts or portfolio-held collateral are made without the need for accessing the Internet.

The method also includes entering into agreements with Retailers and Suppliers enabling their customers to make purchases from them directly using funds taken from the consumer's margin account, the method includes incorporating into the Retailers or Suppliers transaction process the aforementioned secure access rights granted to the company, and includes the Retailers and Suppliers including a pay by margin option on their web site where applicable, and includes enabling purchases to be made against margin as if it were against a credit card account or bank account.

The method includes entering into an agreement with a brokerage or plurality of brokerages with whom clients hold investments and thus may be offered ‘margin loans’ that are secured against their portfolio held investments, where the agreement allows a company to provide an application that gives the brokerage's clients secure access to their portfolios without having to visit the brokerage, and where the agreement permits the company to enable the brokerage's clients to check the balance of their margin accounts without visiting the brokerage site, and where the agreement permits the company to facilitate the brokerage's clients ability to make transactions that directly affect the available balance of their margin accounts. The method further includes confirming the details of a transaction, determining the account details of the consumer, determining that the available margin account balance is sufficient to cover the value of the transaction, completing the transaction, sending confirmation of the transaction to the brokerage and to the transaction source, retrieving funds from the brokerage, extracting any transaction fees, and paying funds to the merchant. The method also includes enabling the customer to instruct the brokerage to sell sufficient equity investments held by the brokerage in order to cover the transaction, in addition to using the margin accounts.

The method further includes the step of enabling a consumer to purchase Products from a plurality of Suppliers and Retailers from a single web site or portal directly against margin accounts, the method includes having agreements with multiple merchants to promote the sale of their Products, providing consumers with access to the Merchant's Products through a web site, providing the consumers with a shopping basket that enables the purchasing of products from the multiple Merchants operating within the portal, enabling the consumer to choose to purchase (in a single transaction) all Products selected directly against margin, employing the aforementioned margin transaction rights and application to complete the transaction, notifying both the Merchants and the brokerages of the transactions completion, retrieving the funds from the relevant brokerage, extracting any transaction fee, and distributing the revenue to the Merchants from whom the Products were purchased.

### BRIEF DESCRIPTION OF THE DRAWINGS

The advantages and aspects of the present invention will be more fully understood in conjunction with the detailed description which follows, and the accompanying drawings, wherein:

FIGS. 1a-1d is a flow chart illustrating the process of selling goods and services associated with Merchant's operations or brokerage operations of the present invention.

FIGS. 2a-2b is a flow chart illustrating the investment purchase process in detail.

FIGS. 3a-3b is a flow chart illustrating the investment sale process in detail.

FIGS. 4a-4b is a flow chart illustrating the process of purchasing products leveraged by portfolio held investment, where a customer purchases from a merchant using credit derived against portfolio held collateral, which, according to the present invention, includes ‘margin accounts’.

FIG. 5a-5b is a flow chart illustrating the ‘Margin Portal’ flow where a consumer visits a portal that enables a consumer to purchase products from a number of online merchants against brokerage held portfolio investments, i.e. directly using margin accounts.

FIG. 6a-6b is a flow chart illustrating the Margin Portal flow where a customer visits the portal partner's web site directly without going through the portal, yet the portal has in place the process to enable the retailer to sell Products against margin and not the retailer as in FIG. 4a-4b.

### DETAILED DESCRIPTION OF THE INVENTION

During the course of this description, like reference numbers will be used to identify like elements according to the different views that illustrate the invention.

As used herein, the term “Company” refers to an entity implementing the invention and therefore, providing the services. As used herein, the terms “Consumer” or “Consumers” refers to the purchasers of goods and services provided by the Company or a partner merchant. As used herein, the terms “Product” or “Products” refer to goods and services available for purchase. As used herein, the term “Supplier” or “Supplier” refer to the ultimate manufacturers or service providers of the Products. As used herein, the terms “Retailer” or “Retailers” refer to direct resellers of Supplier's Products. As used herein, the term “Sales Intermediary” or “Sales Intermediaries” refer to organizations indirectly promoting the sale of Products of Retailers and Suppliers (typically online portals such as Yahoo!) and as used herein the terms “Merchant” or “Merchants” refers to those entities that provide Products for sale and include the Suppliers, Retailers and Sales Intermediaries.

Before describing the Figures in detail, an overview of the process follows to aid in the understanding of the invention.

The process provides those Merchants connected with promoting the selling of Products with a value proposition that results in more customers, greater customer loyalty and long-term value. The process allows businesses to provide consumers with a uniquely rewarding buying experience while also educating and empowering all consumers with share ownership. By providing consumers with equity or equity options and providing easy access to the further purchasing of equity, the process also acquires brokerage accounts and creates demand for new and existing broker/dealer services. By providing consumers with the ability to purchase Products against margin, the Merchants are able to increase the ability of consumers to make purchases cost effectively. The current environment of high competition and unfavorable market conditions has accentuated the need for cost effective solutions to the problems of acquiring and retaining customers for both Merchants and online brokerages.

As already discussed, the invention includes a method and system for acquiring equity investments from the purchase of Products. The method allows consumer purchases to be uniquely and substantially rewarded with ordinary shares or equity options in the manufacturer or service provider from whom Products have been purchased. The method enables sales at a net cost to the consumer lower than offered by the competition and provides a buying experience that is more interesting, informative, enjoyable and rewarding. In addition to saving money, customers also stand to profit from every purchase made as will be later described in reference to the drawings. The equity reward is based upon the notion that when a consumer chooses to purchase a Product they are recognizing merit in the Supplier of the Product and are making an investment accordingly. The purchase becomes a contribution to the future success of that Supplier and the model enables this ‘investment’ to be rewarded with real equity. Advantageously, the equity reward is provided automatically for every purchase, there is no accumulation and redemption of coupons or quasi-incentive currencies required.

The method accommodates both larger value infrequent purchases and low value regular purchases. The purchases may be anything from Information Technology (IT) & electrical goods to medical and home supplies, from insurance to utilities services. The method rewards consumers with equity in all organizations, including blue chips, utilities and hi-tech businesses. The method also provides the opportunity to easily and cost effectively acquire more.

The automatic reward that the consumers will earn is substantial and potentially made even more so by the availability of equity options. The method also gives the consumer the option to invest any increment of spare funds into shares at the time of purchasing a Product, if they see particular merit in the company, its product range or if it appears to be enjoying strong sales for example. There is no prohibitive commission fee that prevents all but significant equity purchases; it could be $1 or $500. Such an ability to cost effectively acquire shares and quickly grow a portfolio at no additional cost is a compelling benefit. It is also a compelling benefit that each reward is redeemable and not an intangible currency that needs to be accumulated in mass, such as airline miles. Accordingly, the consumers have an incentive to remain loyal to the companies that offer this unique value proposition.

The method also promotes consumer loyalty to specific manufacturers and service providers. Particularly as the consumers become stakeholders in these Suppliers and the greater interest of stakeholders and the reward of greater portfolio liquidity will encourage familiarity with all product ranges, product cross selling and repeat purchasing. As an example, customers who are shareholders of a company; visit a company's website 68% more than other consumers and spend 56% more per year at that company.

Accordingly the preferred application will enable manufacturers/service providers, retailers and portals to provide this value proposition to their prospective customers.

Through the method the consumer will have an active equity bearing brokerage account set up at no charge, providing access to a uniquely broad suite of services encouraging development of their portfolio account. Both new and existing equity owners are educated with greater retail investment knowledge and expertise through access to special services that are provided by the present invention, such as the ability to experiment with options in small increments. The consumers will be able to increase the value of their portfolio by the purchase-related services or by traditional brokerage services. The method enables those with offline equity holdings to be freely able to transfer their holdings into their new online accounts. The method also includes providing existing online brokerages with the opportunity to support the invention such that they are able to provide the benefits of the invention to their clients preventing them from having to have a second active equity bearing account in order to receive the equity rewards.

A Supplier will promote the sales of its Products directly, using resellers or ‘Retailers’ or perhaps Sales Intermediaries, the latter particularly through the Internet. In order to sell the Products these Providers will take steps to entice the consumer. Such enticements may include competitive pricing, product information, proficient sales service, efficient delivery and—sales support—all that consumers have come to expect as part of an enjoyable buying experience.

A Provider or Supplier will often look to further promote Products by providing additional incentives to consumers, particularly new or flagging Product lines, perhaps employing mail in rebates, cash back or discounts. The present invention enables the Supplier to provide this incentive in the form of equity or equity options whether purchasing directly from the Supplier themselves, the Retailers, or Sales Intermediaries. This is important because if a Supplier were to publicly provide consumers with a greater incentive to purchase direct, the Supplier would stand to discourage the sales efforts of the resellers upon whom they depend.

The method also uniquely enables the Supplier to provide a reward that is attractive to all, as good as cash if not better (given the opportunity to profit from the rewards) and yet still enables the Supplier to derive loyalty, further customer interaction, and customer profiling information. The cost to the Supplier for providing the equity reward will be accommodated by margin from each sale attributable to promoting the sale or it will be additionally built into the price. The anticipated greater sales volumes and thereby operating economies of scale will also support the cost. The method of rewarding the consumer with equity investments provides the Supplier with two additional benefits; firstly their customers become easily accessible stakeholders interested in learning of other Products and news/opportunities that affect their ability to increase their shareholder value and secondly, where the Supplier is able to provide shares directly, it enables the Supplier to give a non-cash discount.

Retailers will also look to promote Products by providing incentives in addition to those offered by the Suppliers of the Products. Again, the method enables this incentive to be equity in the Supplier of Products purchased by the consumer. This reward can either be taken from the margin paid to the Retailer for promoting and selling the Suppliers Products or the Retailer can build the reward into the Product price. The method enables the Retailer greater leverage on its Suppliers and thereby ultimately helping to finance the reward as: (1) a retail operation that provides customer loyalty, and high traffic volumes will be a more attractive sales channel to a Supplier, and (2) Suppliers will be pleased that the margin they provide the Retailer as commission for sales is reinvested into their own stock so as to help maintain upwards pressure on the share price, particularly as it is distributed in such a way as to encourage long-term shareholders and may be provided directly by the Supplier as a non cash discount on behalf of the Retailer; (3) As the rewards will be apparent to the Consumer each Supplier is encouraged to match or better the equity reward offered by their competition; and (4) Such a value proposition would provide for greater sales volume and thereby provide the Retailer with greater bulk-buying negotiating power.

The method enables the Retailer to provide an equity reward regardless of or in addition to any such reward offered by the Supplier, allowing a cumulative reward with the cost shared between the Supplier and the Retailer as appropriate.

Alternative incentives offered by Retailers such as airline miles require the Retailer to invest in purchasing the rewards prior to the consumer purchasing the Products. At the very least this presents the Retailer with a negative cash position, it also invariably means the Retailer has to purchase more than is required to ensure any unexpected demand is accommodated. With the present method of rewarding consumers with equity or equity options in the Suppliers it means that the equity award is acquired automatically after the consumer has purchased their products. Also as the reward is real and liquid, there is no need for the consumer to accumulate intangible points with no value unless through significant aggregation, and there is also no danger of affiliating with a reward scheme not valued by certain consumers as there is with airline miles.

Both Suppliers and Retailers use Sales Intermediaries such as online portals to promote themselves and the Products they sell. The method also allows such Sales Intermediaries to offer the consumers purchasing through them an equity reward in the Supplier of the Products they are purchasing, and again this may be in addition to the equity rewards offered by the Retailer and the Supplier. The primary role of the Sales Intermediaries is to attract an audience likely to purchase Products and to encourage this audience to purchase. In return for generating sales the Sales Intermediary is typically paid a royalty or commission on any sales generated through its promotion of the Supplier or Retailer. This is often referred to as an ‘affiliate fee’. In order to prevail, such Sales Intermediaries must also entice consumers to purchase Products, thus providing the Sales Intermediaries with commissions and the leverage to charge higher advertising rates. The method again allows for a cumulative reward with the cost shared between the Sales Intermediary, Supplier and the Retailer.

A consumer visiting a Merchant or a Merchant's web site considering a purchase will be made aware of the value of the reward they will receive and the amount of Supplier's equity or equity options the reward will provide them at the current market prices. The Consumers are made aware that there may be a delay in the purchase of the equity to allow for administrative actions such as product returns and, therefore, that the number of shares that can be purchased by the reward may vary. At the time of transaction the Consumer determines whether or not to add any incremental sums to the value of the transaction in order to acquire more equity in the Supplier. Where relevant, the Consumer will be made aware at this time of any transaction fee or commission. While this is unlikely to apply to the reward it will apply where the consumer wishes to acquire additional shares. The commissions for the purchase and sale of the equity will be approximately 1-2% with no minimum; therefore even on a $20 purchase for example this is a nominal fee.

The Consumer purchases the Products from the Merchant. Upon purchasing the Consumer will indicate their wish to receive the investment reward. This provides the first consumer declaration of interest in owning equity in the Supplier. The Consumer is credited with a rebate equivalent to the published equity reward, i.e. a percentage of the transaction price that will be automatically be provided in the form of equity or equity options, in addition to any sums added at the time of transaction.

Where a Consumer is making their first purchase that generates an equity reward, the Consumer will receive a nominee account into which the total rebate will be credited. The account set-up procedure will follow the regulatory guidelines specified by the SEC (Securities and Exchange Commission). As much of the required account set-up information as possible will be extracted from the Merchant's derived customer registration information in order to minimize duplication of effort.

From this point on, where equity rewards are fulfilled and managed by a party or Company independent of the Merchants, any further purchase generating an equity reward from any merchant will be automatically credited to the Consumer's personal account and the Consumer will receive confirmation of this at the time of the transaction. Where the Supplier will be providing the equity directly the balance may not be actually held by the party or Company managing the account. Where the Supplier is not providing the equity directly, i.e., the equity in the Supplier will be purchased, or where the Consumer requests a reward of equity options, the monetary equivalent required to purchase the equity reward will be retained in the account. The money will be held in the account for the duration of the returns period where applicable. The Consumer account holder is unlikely to earn interest throughout this time.

In order to minimize the cost and administrative effort of acquiring and selling shares, the rewards earned by each consumer will be collected according to the specific Supplier. The equity will either be acquired directly from the Supplier, for example, Ford Motor Company, in the instances where the Supplier offers such Direct Share Purchase facility, or the shares will be purchased through an exchange in batches of value great enough to justify the transaction fees. The batch process enables the cost-effective purchase of both equities and equity options. The advantage of obtaining equity directly from the Supplier is that there are no broker commissions. The Supplier is also able to provide a non-cash discount where it is liable for the reward itself and recognize greater revenue where the cost of the reward is attributable to a reseller. The method of purchasing/selling will enable the fractional distribution of shares to all contributing consumers, this may be achieved through dollar based batch dealing or through setting up mutual funds with only the one equity holding and giving Consumers rewards that reflect their contribution to the fund.

The successful implementation of the batch purchasing is facilitated by the delay in purchasing shares due to the returns period. As the Consumers are receiving these shares essentially for free, the method fully anticipates that the Consumers will understand the need for the delay as part of the process. Furthermore, the process gives the consumer an insight as to how the partners are able to offer such a great reward scheme when the perceived costs are so high—helping to dispel thoughts of a ‘catch’.

In addition, when shares are to be purchased, the Company will first check to see if corresponding shares in the same provider by other Consumers are to be sold. In the case where equity rewards are being bought and sold, the brokerage will simply net off these orders and in so doing receive the commissions for buying and selling while also receiving the spread between the bid and ask prices.

The method also provides a mechanism whereby all account holders are able to contribute funds to a batch purchase of equity or equity options, whether they have purchased Products or not. This will allow a cost effective mechanism of purchasing investment in small increments for all account holders.

The consumer will be encouraged to enter their account prior to the purchase of their reward. The purpose of this is twofold;

i. to enable the completion of any administrative & regulatory duties associated with account set up that cannot be executed at the time of product purchase;

ii. to begin and encourage further interaction between the broker operation and the investor.

At anytime prior to the purchase of the equity reward the Consumer is able to add any increment to the value of the reward should they wish. With the commission being so nominal, the brokerage can enable investors to invest only $25 if that is what they have free to invest. In so doing, the brokerage removes the barriers suggesting one needs significant sums at a given moment to invest in shares economically, it also enables Consumers to add small amounts to round up the rebate such that it is neatly divided by the shares purchased and the commission fee.

It is worthy of note that where the Consumer believes the volume justifies the instant purchase or sale of equity as opposed to batch, they may do so invoking standard fees.

This is envisaged where a rebate is added to by the Consumer prior to purchases, or where a Consumer is selling rebates that have been added to by further purchases of products or traditional share purchases.

When the rebates have cleared any period assigned for returns, the equity or equity options are acquired. The Consumer account will be credited with the actual equity or equity option that can be acquired at the time of the transaction. It is envisaged that the batch purchases will be regular events and accordingly, it may be possible to allow an investor to choose a batch purchase through which they would like their purchases to be made.

In the event that the Merchant or Provider is promoting the sales of Products that do not originate from a publicly quoted Supplier, the Merchant or the independent Company managing the accounts will issue the consumer with a representative share of the Company's mutual fund. This mutual fund will be compiled by a share holding in each of the publicly quoted suppliers whose products are being sold.

Once rewards are credited to the Consumer's account, the Consumer is able to track the performance of their portfolio and if required, source additional and perhaps more traditional broker dealer services and also transfer any investment assets held elsewhere into the account. The accounts will provide all details of the Consumers Product transaction, the reward purchase price, information relevant to the Suppliers whose equity they own, mark to market profit and loss analysis and so forth.

The Consumers are encouraged to grow their portfolios with further purchases of Products and more traditional purchases of investments however the method also provides a mechanism that enables the Consumers to sell their equity rewards where the rewards are being managed by and independent company. Unless otherwise requested by the Consumer, the Consumer's equity will be sold in batches in the same manner in which it was bought. The Company will where possible net off any sales with any demand for shares in order to minimize the cost of the transaction in purchasing equity. The Consumer can opt to sell their holding immediately and not wait for a batch purchase, however, such a transaction would be subject to typically higher transaction fees.

As described above, the invention uniquely combines Consumer purchasing and retail investment. This is further demonstrated by the method providing Consumers with the ability to make purchases on credit collateralized by brokerage held investments. The Company managing the fulfillment of awards, whether a Merchant or an independent organization, enters into agreements with online brokerages. The agreements enable the company to provide the brokerage clients with access to their accounts from a source other than the brokerage itself. The Company will use a computer software application adopting the same security measures employed by the brokerages. The agreement will also enable the Company to provide through the computer software the ability for the client to make transactions against their portfolio holdings. Most notably, this will enable the Consumer to make transactions affecting the availability of their margin accounts. However, the method also provides a vehicle whereby the Consumer is able to instruct a brokerage to instantly sell the securities in a company in order to finance at that time, and seamlessly, the purchase of Products. Therefore the computer software application enables payments using the available margin funds or automatically liquidating portfolio holdings.

As previously discussed, margin loans are collateralized by client investment assets of greater value than the available credit line offered by the brokerage and the brokerage has the right to liquidate these assets. Therefore the brokerage is able to charge interest on these margin loans and thereby profit, knowing that there is no risk of client default in repayment. It is therefore a highly desirable source of income. The brokerages currently depend on the interest on margin loans for a very significant part of their profit contributing revenue and therefore wish to encourage the use of margin loans by clients. Currently the margin loans can only be used to purchase further securities and during the slow downs in investor activity in bearish market conditions, this source of revenue falls. Thus, the brokerages need to encourage clients to use their margin loan facilities.

The advantages to the Consumer of being able to make purchases against margin are primarily related to the fact that they are able to receive very preferential interest rates on the loans, far less than credit cards or unsecured bank loans. Therefore to be able to purchase products using low cost credit as opposed to high interest rates associated with credit cards is a highly attractive alternative. It also enables consumers to keep favorable equity investments at times when the consumer requires cash to pay for goods or services such as purchasing a car, paying bills, Christmas, Holidays and so on. Consumers may also wish to avoid brokerage fees or incurring the hassle of selling investments, and transferring the resulting funds into a bank account in order to finally make the transaction for which they require the funds. It is worth noting at this point that the FTSE 100 has returned an average of 12.5% over the last 80 years, a margin account is typically 1 or 2% over base rate i.e. 6-8%. It is therefore preferential to retain stocks and earn a return of 12.5% and borrow against them at a cost of 6-8%, making a net gain of 4.5-6.5% return.

The company will provide access to the computer software application method of enabling clients to make transactions against their margin accounts to any Merchants. Thereby the Merchants will be able to offer Consumers a ‘pay by margin’ facility when selling goods, in much the same way as the Merchants allow payment by VISA, MasterCard and American Express. This will be preferential to the Merchant as firstly any way to make it easier for Consumers to make purchases is to their advantage, and secondly it is not anticipated that the Merchants will be charged the significant transaction charges imposed by many credit cards such as American Express.

Accordingly, a customer will be able to indicate a desire to purchase Products using their margin account. They will input their secure personal information such that the company's computer software application can identify the client, access the client's information and provide confirmation that there are sufficient funds in the margin account to cover the transaction. The Consumer will confirm the transaction, the Company will immediately deduct the funds from the clients available margin account balance, and once it has done so, send confirmation to the Merchant and to the brokerage. The brokerage will then be able to start charging interest on funds that have been spent until such time that the client repays them. The method allows for transactions made against margin accounts to also generate equity or equity options rewards. It is possible for these rewards to be greater than otherwise earned: the brokerage may wish to offer consumers an incentive to purchase in this manner and the retailers may contribute to the reward in lieu of funds saved that would otherwise have been allocated to making the transaction or having a credit card do it on their behalf. Purchasing directly against margin is anticipated to be particularly important when purchasing big-ticket items such as cars where finance is often required and offered at a high unsecured interest rate. Purchasing a car on finance of 7% Apr (annual percentage rate) is far more attractive than purchasing at the typical 10-12% Apr.

When the method of the present invention is employed as a portal on the Internet, Consumers will be able to buy products from any potentially any Merchant or Provider against their margin accounts. The Company will retain the agreements with brokerages and enter into agreements with Merchants concerning the promoting of their Products with the Company managing the transactions on their behalf. This means that the Merchants do not have to have had incorporated the transaction method into their operations. The consumer will be able to visit the portal, select to buy Products from any Merchant therein by placing the products in a ‘global shopping’ basket and purchasing them in one transaction against their margin accounts. The company computer software will again check the consumer's account and available balance, deduct the appropriate funds, and distribute the funds to the Merchants from whom the Products have been purchased.

Thus, alternatively, a Supplier, Retailer or Sales Intermediary could preferably implement the method and system of the present invention wholly and independently. A more preferred application however, is where all Suppliers, Retailers and Sales Intermediaries promote all of their Products using the present business method invention with an independent company providing the fulfillment infrastructure on behalf of the Merchants. The independent company providing the fulfillment infrastructure can increase the value and desirability of the equity reward to the Consumer, thereby increasing the promotion of the merchants Products and to reduce the cost burden to the Merchants for implementing the method. To clarify; having a standardized, centrally-controlled account management will enable a Consumer to purchase from a plurality of Merchants and receive their equity reward directly into one personal online brokerage account, an account by which they can access further brokerage services from the company or from partnering online brokerages. It will eliminate the need for the Consumer to have multiple disparate accounts set up by independent Merchants or, in the absence of accounts, multiple share certificates that need to be manually transferred into an account after every purchase. This application will also centralize the demand for broker services such that economies of scale in operating expenses can be enjoyed enabling a Company to provide on behalf of all Merchants a greater service at a cost less than would be incurred through operating the method and system of the present invention directly.

Furthermore a central management function enables the independent Company to maintain a live database of all Merchants, Products and their rewards that is used to form a valuable one-stop, equity reward shopping directory provided to a network of Sales Intermediaries to further promote the sales of Products. The database will be constantly updated to reflect every reward offered by each Merchant on every Product at any given time and it is beneficial to Consumers to have access to such a directory to this information on equity rewards. Accordingly, the Company will make available a directory and application (‘Application’) to Consumers either directly from its own web site or a network of online Sales Intermediaries such as AOL, Yahoo! and MSN so as to further promote the Products of the Merchants.

In so doing the Company will themselves act as a Sales Intermediary on behalf of the Merchants. Merchants would be able to enter into agreements with the Company whereby the Company promotes the sales of their Products through the directory. As with all Sales Intermediaries, under the agreements the Company will earn a commission or affiliate fee in reward for any sales generated by the Company's application. Typically such affiliate fees range from 5% to 20%.

However, the Company will pass the majority of this commission to Consumers in the form of the equity or equity options reward, thereby increasing the value proposition to the Consumers. And as the Company will earn commission on all sales it generates and pass it on to the Consumers in the form of equity rewards, it follows that the Company can sell the Products of any Merchant and still offer the Consumer equity rewards. In this method, it guarantees that the consumer is not wholly dependent on the Supplier or Retailer determining which Products offer equity rewards. Thus, the database directory would be limitless, enabling all Consumers to be able to purchase all Products and receive an equity reward, and have the opportunity to acquire additional equity.

Included in this method, in addition to online portals the Company provides brokerages with the ability to incorporate into their site the one stop equity reward shopping Application. By entering into agreements with the brokerages such that when any of its clients or site-users purchase Products earning equity rewards, either through the Company's directory, or directly through a Merchant, the equity rewards may be accredited to the Consumer's existing account with the brokerage. Alternatively, the Consumer may have an account set up by the Company that is intrinsically linked to the brokerage. In so doing, the Company enables a brokerage to improve its value proposition to its existing and prospective clients, convert browsers of their site into account holders, while also ensuring that current account holders do not have to run a separate account with an alternative brokerage to benefit from the equity rewards provided by the invention, therefore increasing client retention.

In the United States alone there are in excess of 70 million consumers with retail investments held offline and it is well known that a great many of these Consumers readily use a brokerage's online content to manage their offline portfolios. All brokerages are keen to convert these users of their content into account holders, as they are actively interested in equities and will have offline assets that could be transferred online to be managed by the brokerage.

Naturally users of the directory application will conduct searches for items of merchants not providing equity rewards and therefore not listed. For this reason, and to provide greater search facilities to the Consumers, the Company may enable established portals to provide a greater search engine that supports the Application in default. In effect, the Company will provide portals with the opportunity to provide their directory services to the company's network of intermediaries, including the brokerages. In return, the portals will incorporate the application into their own site and therefore promote the further sale of Merchant's products and lead to the education and empowerment of Consumers with share ownership.

Accordingly, the method satisfies the need for manufacturers, services providers, retailers and online Sales Intermediaries to successfully promote sales online and offline, maximize customer attention and ensure long term customer loyalty. The preferred application also satisfies the need for the acquisition of active online brokerage accounts and the need to increase demand for broker services by educating and empowering consumers with share ownership.

These and other features of the invention will be more fully understood by reference to the following drawings.

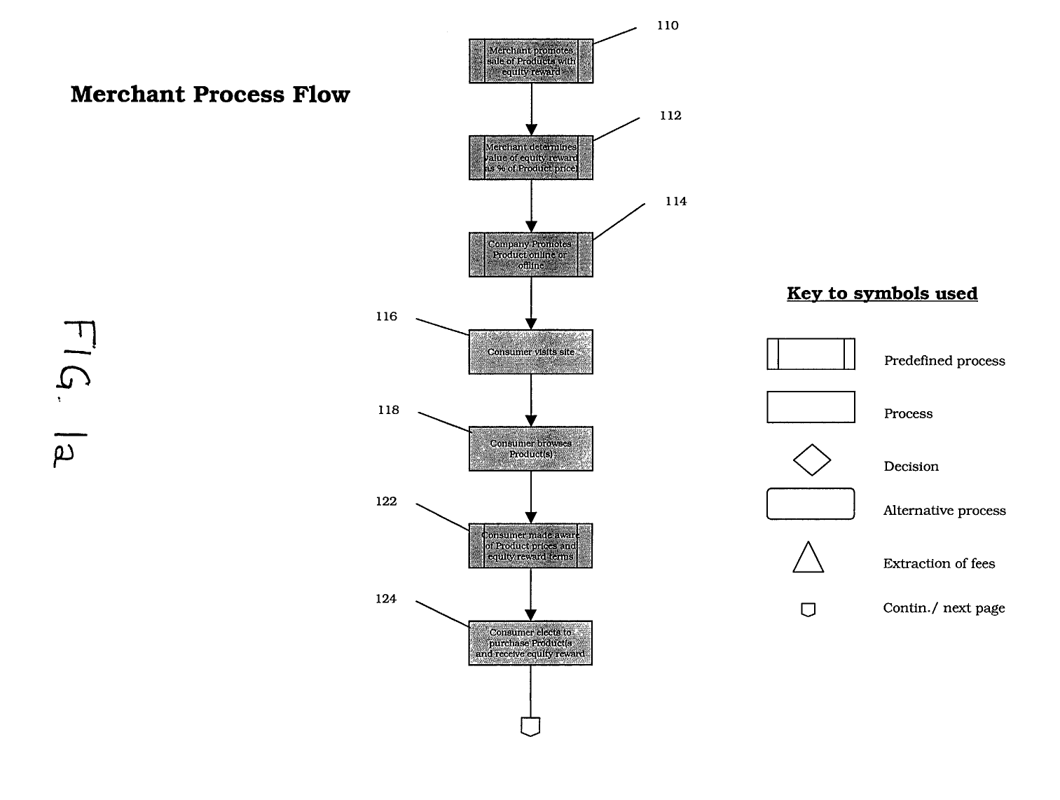

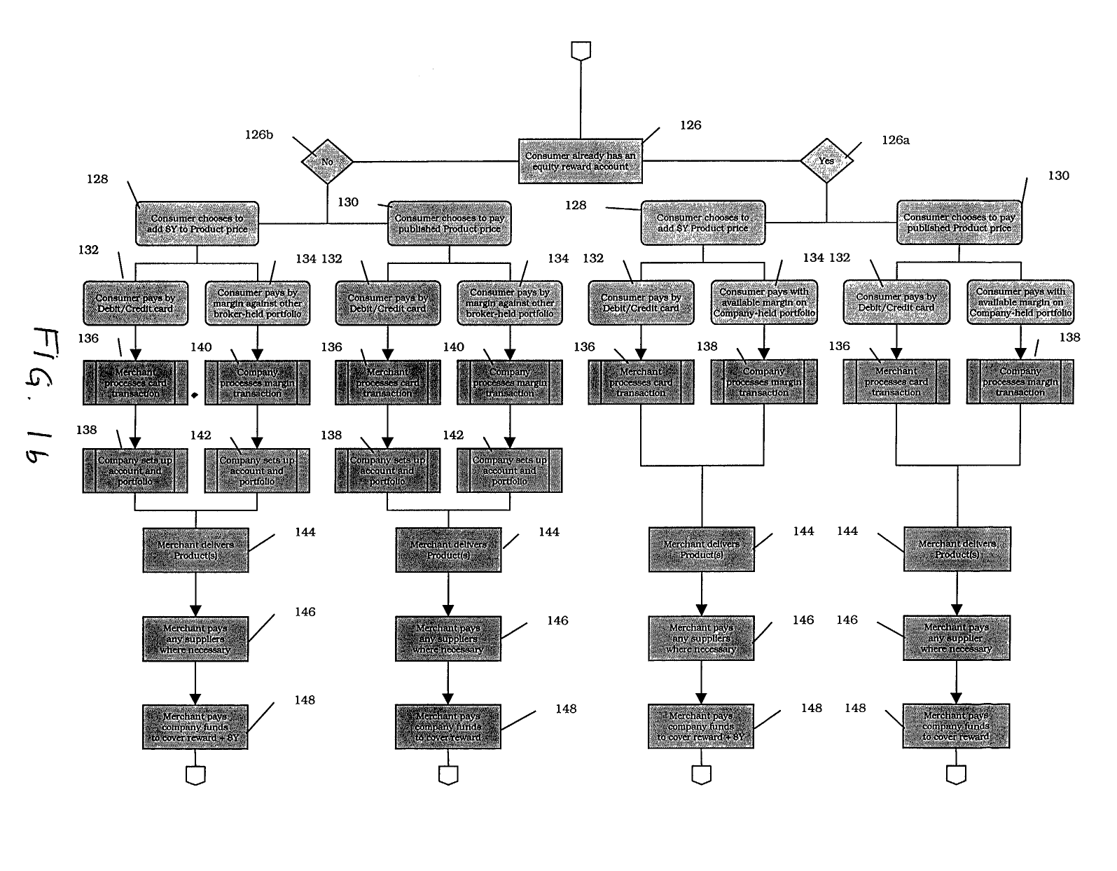

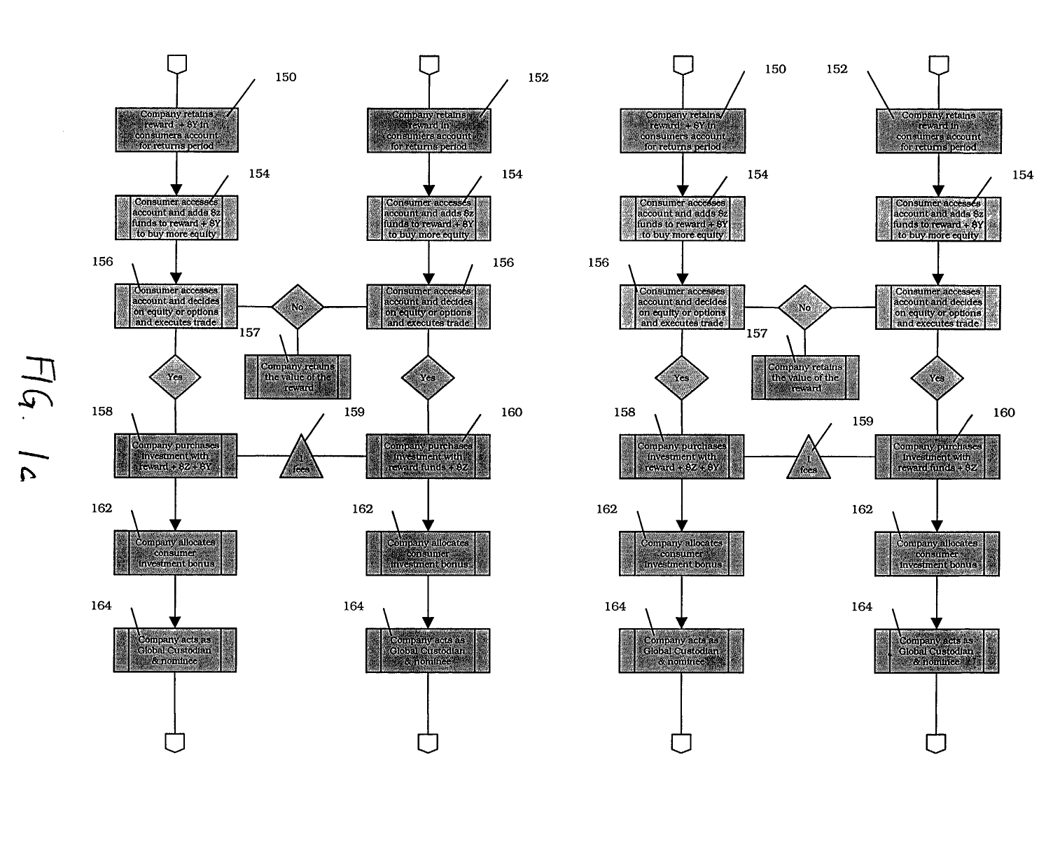

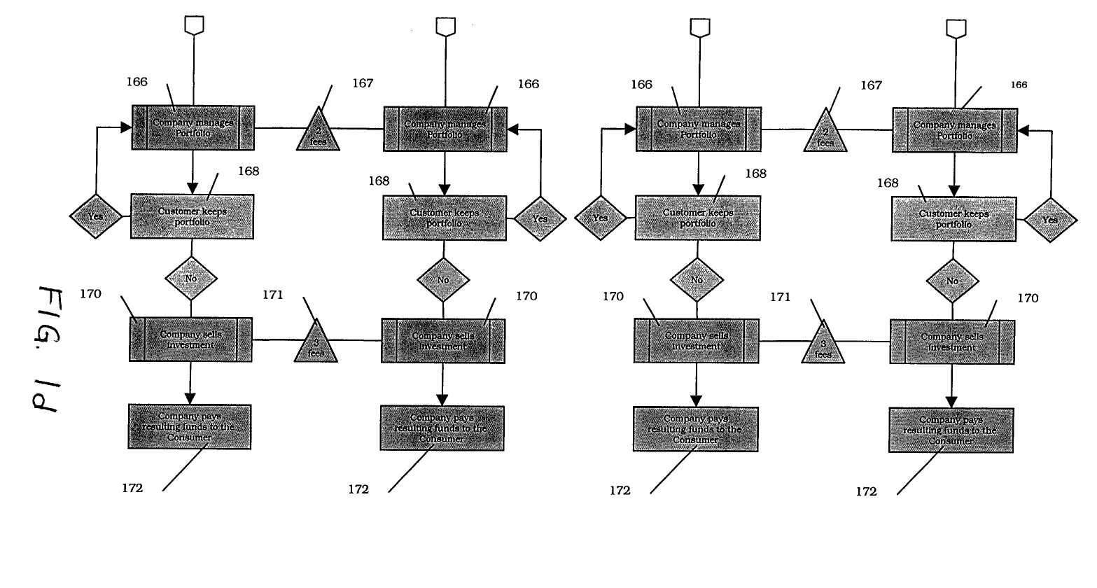

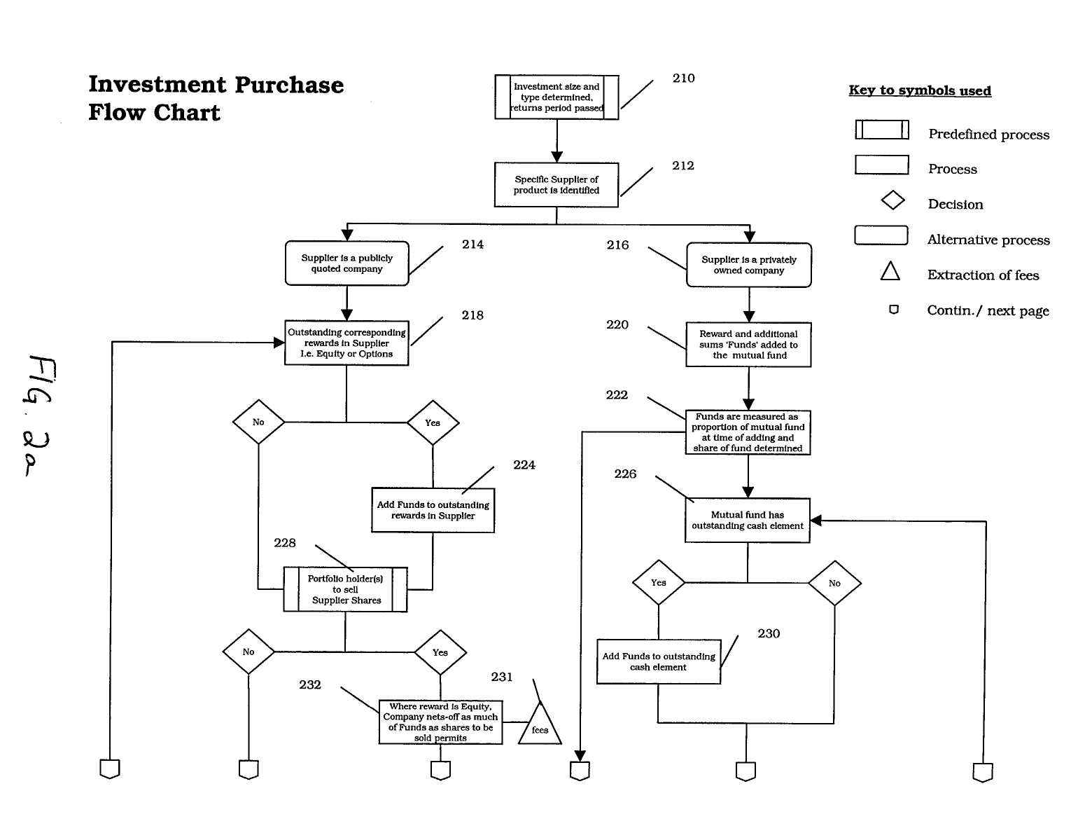

Referring to FIGS. 1a-1d, which illustrates a preferred embodiment of the invention, a Merchant, be it Supplier, Retailer or Sales Intermediary has determined to offer equity rewards on Products it promotes 110. There is no restriction to the Products the Merchant can choose to promote with the equity rewards or the Suppliers, i.e., Suppliers may be publicly quoted companies or privately owned companies. Upon selecting the Products that the Merchant wishes to promote with equity rewards it determines the value of the reward as a percentage of the transaction value 112. As the reward can come from any or all of the Suppliers, Retailers, or Sales Intermediaries, the determining of the reward may be a collective effort or conducted solely by a Merchant alone depending on how many parties are involved in financing the reward. Having determined the reward to be given on the Products, the Merchant promotes the Products to encourage sales 114. This can be conducted either online, offline or both depending on the operations of the Merchant.

Upon visiting the Merchant shop or its web site 116 the Consumer is able to browse through the Products offered for sale 118 by the Merchant, and is made aware of the prices and terms of rebate pertinent to each Product. Such terms will include the size of the reward as a percentage of the Product value, whether the reward offers the choice of equity and equity options or whether the reward is a share in a company's mutual fund, any returns period, during which products may be returned to the Merchant and therefore cause a reciprocal period of delay in the purchasing of the reward and notification of any commission fees should the consumer wish to purchase additional equity when making a Product purchase.

Upon a Consumer committing to making a purchase 124 the consumer indicates their option to receive the equity reward. Referring to FIG. 1B, a Company determines whether or not the consumer already has an equity reward account and portfolio 126 at the time of purchase, and if yes 126a, updates the account information with details of the recent purchase. The Consumer is given the choice of adding further increments of money $Y, in any amount, to the price of the transaction 128. This enables the consumer to increase the equity reward received in the Supplier and may be, for example, prompted by indications of strong sales of the Suppliers Products through the Merchant, or the Consumer may simply wish to invest some spare cash. Regardless of the options 128 and 130 available to the Consumer, payment is made by cash/debit/credit card 132, or by margin against other broker-held portfolio 134. If paying by margin 134, the Company generates a payment instruction that deducts the transaction amount directly and seamlessly from consumer's available portfolio margin 140. If the Consumer pays by cash/debit/credit card 132, the transaction is processed 136 by the Merchant and thereafter the Company sets up a brokerage account and portfolio for the Consumer 138 if the Consumer has not already received an account. Likewise, where the transaction is made against margin 134, when the transaction has been confirmed, those without an account will receive one 142 into which all transactions relating to the Customer are logged. Thereafter, the product is delivered by the Merchant 144, and where the Merchant is not a Supplier the Merchant will make any necessary payments to the Supplier 146, and the Company may deduct an administration fee for any services conducted on behalf of the Merchant 148. Services include purchasing, holding, and managing and the investments acquired in each Supplier, among others.

The accounts 138 and 142 store records of all Products purchased, price paid, and debit/credit card details, for example. The accounts 138 and 142 also hold information relating to the consumer's portfolio, i.e., shares received as an equity reward for retail business, additional shares purchased, excess funds held in the account, money market instruments etc.

Referring to FIG. 1c, as a result of the transaction, the Company retains the equity reward funds plus the amount of money added by the Consumer 150, or retains just the equity reward funds 152 in order to purchase investments 158 and 160 in the Supplier of the product. It is possible that the Company does not actually receive these funds depending on the equity reward and how it is to be acquired. For example, where the Merchant is providing a reward in a Supplier that offers Direct Share Purchasing facilities the Company need not enter the market to purchase the shares and thereby incur broker fees. Instead, the Company is provided with the shares at the time of acquisition, by the Merchant passing the funds associated with the equity reward directly to the Supplier, unless the Merchant also is not a Supplier. The Company will retain the funds in the Consumer's account until the returns period has passed 150 and 154. The returns period is typically 21 days during which the Consumer is unlikely to be receiving interest on the account balance. During the returns period, the Company provides the Consumer with the opportunity to add further incremental amounts $Z to the value of the equity reward used toward purchasing the equity investments 154. This may be a matter of pennies in order to round up an additional share or a matter of dollars to acquire additional equity in the Supplier. Consumers are able to add to their portfolio in any increments of money or indeed shares, and, using the method of the present invention, do so cost effectively. The Consumer is also encouraged to access their account and determine whether they wish to receive their equity reward in ordinary shares or equity options. Depending on whether the Consumer has added to the equity reward funds, the Company manages the equity reward fund plus $Y and or $Z with which, the Company will acquire the equity in the Supplier of the Product(s) sold to the consumer 158 or 160. If the Supplier is not a publicly traded company, the Company provides to the Consumer a representative portion of the Company's mutual fund. Where equity is purchased, and not provided directly from a Supplier, the Company need not purchase equity after each transaction by the Consumer. Instead, the company accumulates batches of all the equity funds reward that relate to specific Supplier during the returns period 150. Thus, the Company is able to make large transactions that justify any brokerage expense incurred through the trade. The equity and equity options may be purchased either using dollar based trading such that fractional shares can be awarded to Consumers. This is particularly important when the share price of the Supplier is high relative to the size of the equity reward, or with mutual funds set up with only one share holding in which the Consumers receive a share, again enabling fractional ownership of shares. Fees 159 are deducted by the Company when purchasing investments. The investments purchased in the Supplier are then distributed to the Consumer's accounts 162.

As global custodian and nominee, the Company holds the investments 164, and manages the Consumer's portfolio 166. Thus, the Company does not have to send out share certificates for each purchase. Referring to FIG. 1d, Management of the portfolio 166 involves performing Corporate actions (such as payments of dividends) providing real-time portfolio tracking, buy/sell/transfer transaction services, discussion groups, making available other market instruments and financial services, and enabling retail purchases against portfolio margin. For the services provided, the Company may charge a fee 167. Of course, the consumer keeps the portfolio as long as desired 168. If the Consumer wishes to dispose of the portfolio held investment, the Company sells the investment 170 and pays the resulting funds to the Consumer 172. In selling the investment, the Company charges a fee 171 for the transaction, and again employs a batch process regardless of how few shares are being sold to make it cost effective for the Consumer to liquidate their assets.

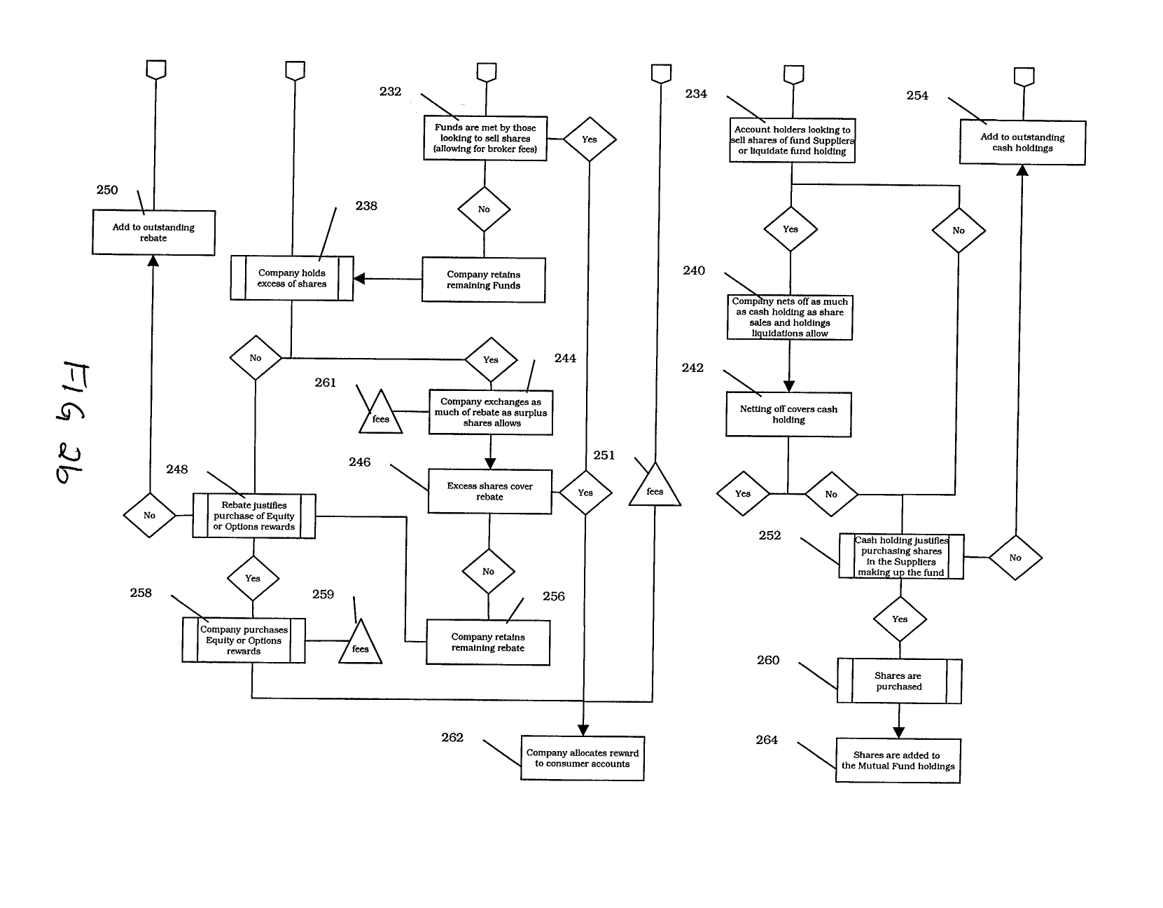

Referring to FIG. 2a-2b, the Investment Purchase process is illustrated in greater detail. As illustrated in FIG. 2a, the process starts from the point at which the value of the equity reward is put toward purchasing investments after the returns period has passed 210, the Consumer will have indicated a preference for equity or equity options where appropriate and the specific Supplier whose Product(s) have been purchased has been identified 212. The value of equity or equity options to be purchased on behalf of the Consumer will be dependent on both the equity rewards generated from the purchase of Products and any additional amounts of money added at the time of transaction or during the returns period. It is also determined whether the Supplier is publicly quoted on an exchange 214, or privately owned 216. If the Supplier is publicly quoted then the equity reward will be used to purchase equity or equity options in the Supplier 218, if not, then the consumer's equity reward will be used to purchase a representative share of the Suppliers mutual fund 220.

Where the Supplier is privately owned 216 and the Consumer is to be rewarded with an investment into the Suppliers mutual fund 220, the Consumers equity reward and additional funds are added directly to the fund 220. A proportionate value of the consumers investment into the fund 222 is automatically accredited to their brokerage account 262. This is made possible as the mutual fund will be able to carry a cash element and so amount of the reward can be instantly absorbed into the fund.

Where the Consumer funds are to purchase equity or equity options in a publicly quoted Supplier 214, the Company will determine whether there are any other corresponding equity rewards associated with that Supplier 218 at that time. By this it is meant that should there have been a number of Consumers purchasing from the same Supplier in a given time period, and thus there will be additional equity reward funds available to purchase investments in the Supplier.

If there are other additional equity reward funds available to be used to purchase equity in the Supplier or units in the mutual fund the funds are added to minimize the number of transactions that need to take place 224. Once the collective funds have been determined, the Company then determines whether any Customers wish to sell shares in the given supplier 228. In that case, the Company nets off as many of the shares to be purchased with the shares to be sold 232. The Company may deduct fees that equate to the spread between the bid and ask price of the Suppliers equity as per the published quotes at the time and the broker fees for conducting the acquisition of equity even though the Company is not entering into an exchange to purchase the investments.

Where the funds have been incorporated into the mutual fund, the Company uses these funds to purchase a greater shareholding in the Suppliers for the fund. The process of doing this first includes identifying whether there is already a cash element to the fund 226, and if there is, adding the consumer's funds to it 230. By reference to FIG. 2b, it is demonstrated that in order to cost effectively purchase equity for the mutual fund, the Company will first determine whether there are any Consumers looking to liquidate a holding in the mutual fund or sell shares that are included in the fund 234. Where this is found to be the case the Company will net off the cash element of the fund with such Consumers looking to sell their investments 240. Where the opportunities to net off cash for shares sold are not available, the Company will consider whether the cash element that remains is sufficient to acquire the equity 252. The equity may be acquired either directly from the Suppliers or through an exchange; either way there is a cost involved. If the outstanding funds justify a transaction the shares will be purchased 260 and attributed to the mutual fund 264 and if not, the funds will be retained in the Company's mutual fund 254 until they are added to by further Consumer equity rewards or until it is possible to net off with Consumers wishing to liquidate their holdings.

Referring still to FIGS. 2a and 2b, in the purchasing of equity, the amount of investments to be purchased to be netted off against those consumers wishing to sell the same equity is measured 232. If the collective rebate is met entirely by the value of customer shares/units that are to be sold, 234 the process is complete and the shares are accordingly allocated to the Consumers 262. Where the rebate funds cannot be netted off in entirety the Company will retain the remainder of the funds and determine whether they can be netted off against the Company's holding of shares 244 and 246. The Company may have a holding of equity in the Suppliers 238, particularly in the early stages of implementation, when sales volumes may be low and the anticipated time to accumulate batches that justify individual share purchases proves prohibitive. In this scenario the Company may make a bulk purchase of equity hedged by options from which it is able to directly able to broker the Consumer's equity reward when they purchase products in the Supplier. If this is possible the Company will deduct fees when netting off the rebates with those Consumers wishing to sell the shares as aforementioned 231. Where this is not possible, the Company will retain the funds 256 and determine whether the collective outstanding funds justify the cost of acquiring the equity or equity options and whether, in the case of equity, they may be purchased directly from the Suppliers 248. In the case that the collective value of the funds justifies acquiring the equity or options 258, the Company will execute the transaction, deduct transaction related fees 259 and allocate the investments to the consumer's account 262. If the value does not make a transaction economically viable the Company will retain the funds 250 and 218, until such time that they are added to by further rebates or can be netted off by those wishing to sell equity in the same Supplier 232.

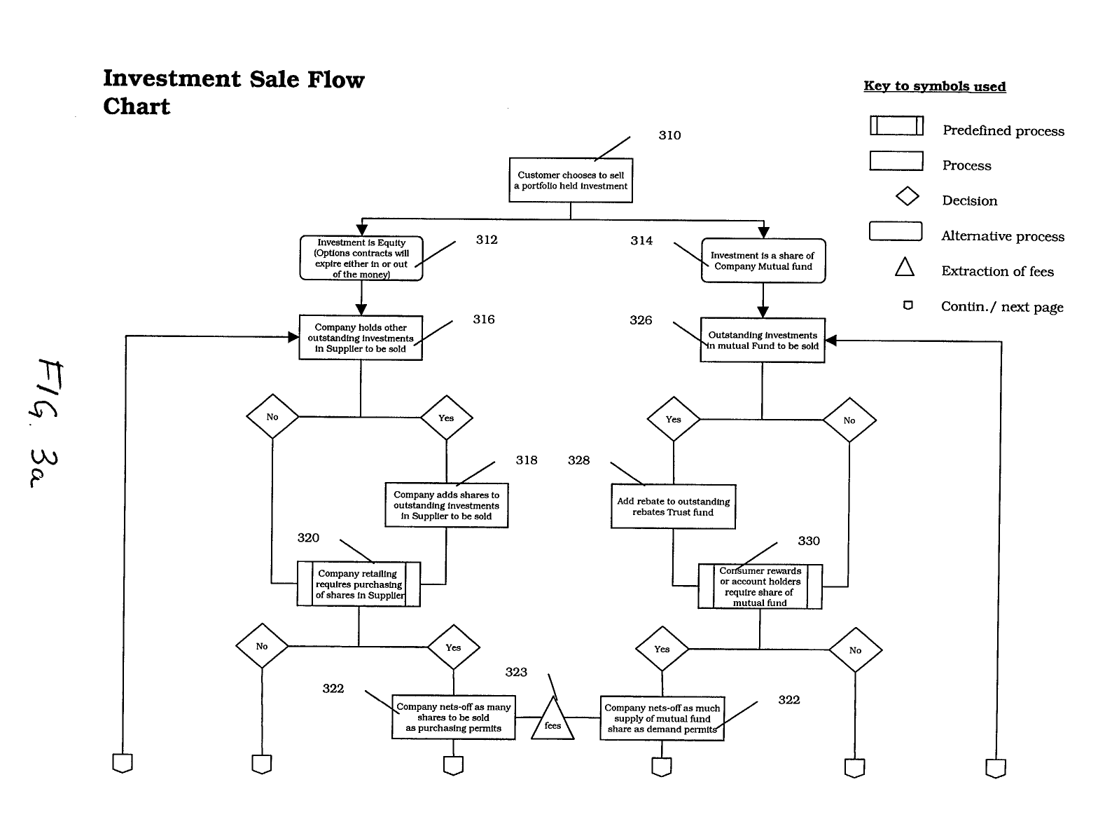

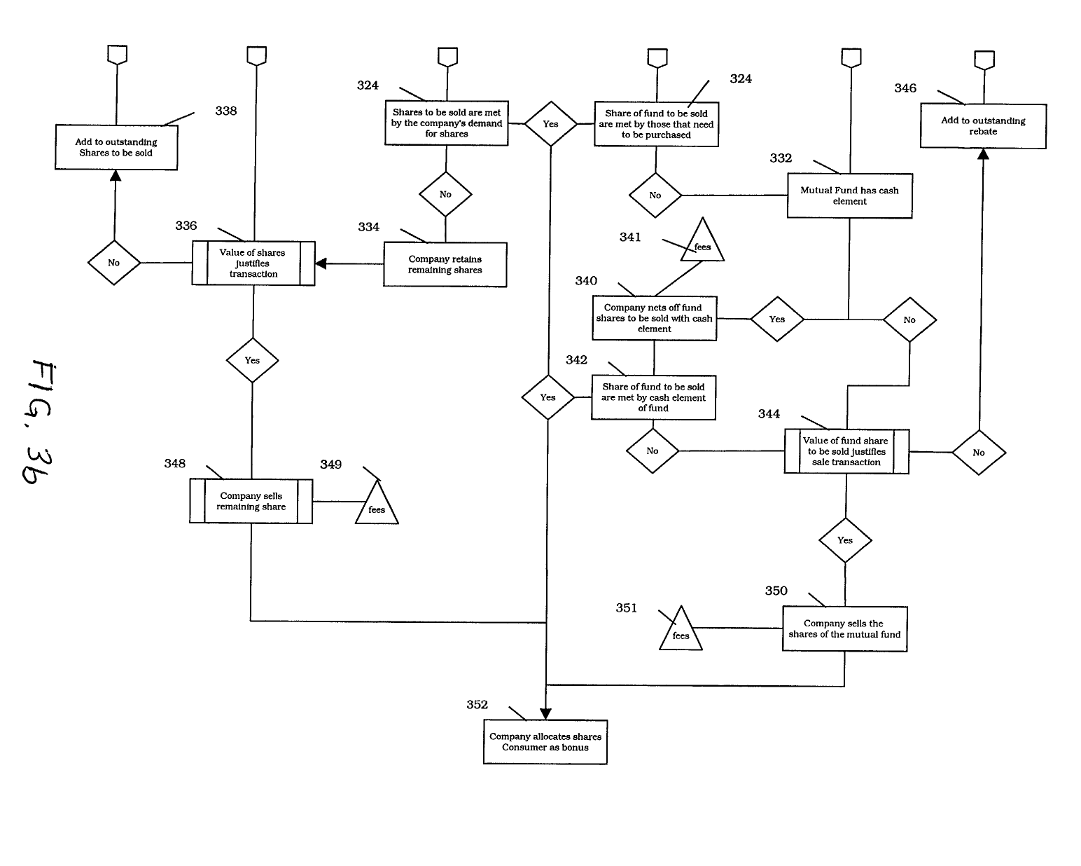

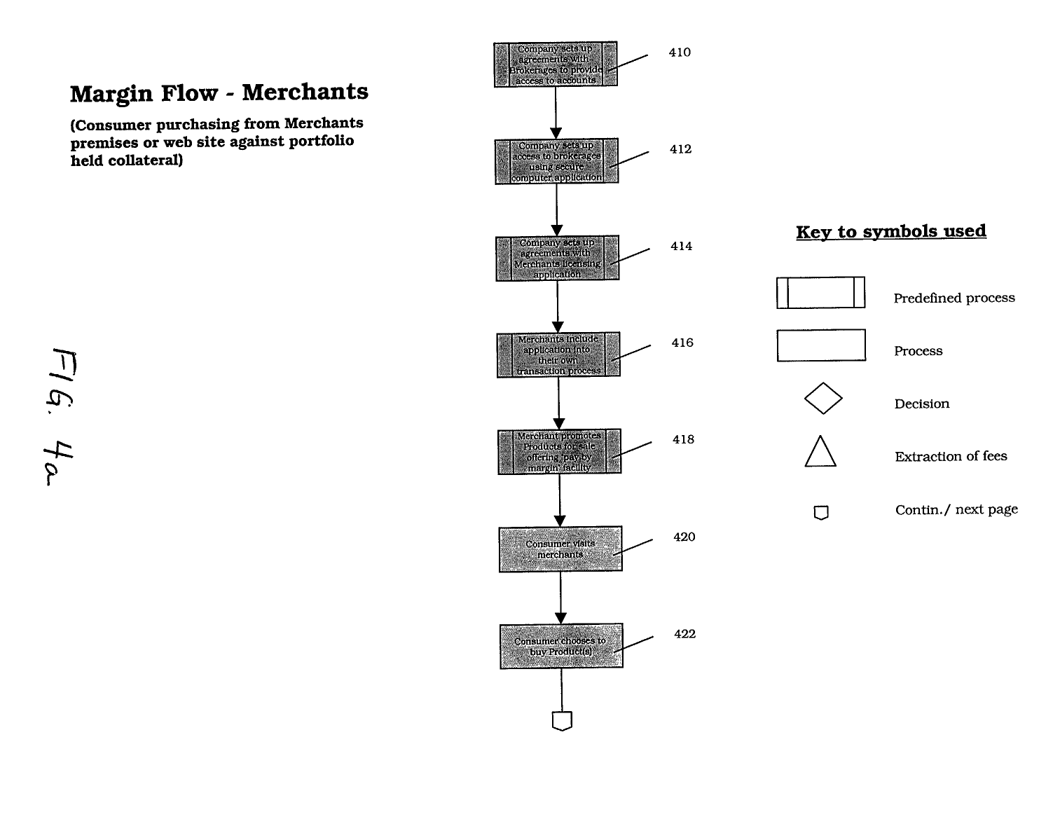

Referring to FIGS. 3a & 3b the Investment Sale process is illustrated in more detail. When a Consumer chooses to sell a portfolio held investment 310, it is first determined whether the investment is equity of a supplier 312, or a share of the company's Mutual fund 614.

If the investment is equity 312, and the Company has other customers wishing to sell equity in the same Supplier 316, the Company pools the shares to be sold together in order to minimize the number of transactions that are required to fulfill the Company's commitment to sell shares 318. Likewise where the investment is in mutual fund 314 the Company identifies whether there are other customers wishing to sell their share in the mutual fund 326. In that case, the Company pools the units to be sold 328, as was likewise done with the aforementioned equity.

The Company also determines whether it actually has a requirement of the equity being sold 320, or share of the mutual trust fund being sold 330. If the Company has a need for the equity or mutual fund share, it nets off the shares with the rebate from the Consumers retail purchases 322. At this point fees 323 are extracted through the commission for the sale.

If the shares or units in the mutual fund to be sold are matched by the Company's demand for the same investment 324, the process is complete and the customers selling their investments are allocated the funds generated by the sale 352. Where the volumes of equity or mutual fund to be sold are greater than the Company's demand for the same, the Company retains the remaining shares or units 334.

In the case of selling equities, the Company determines whether the value of the remaining investments justifies a sell transaction on their own 336. If this is the case, the equity or units are sold 348, a fee is extracted 351, and the customers are allocated the resulting funds generated 352. If not, the company retains the shares 338 and 316 for a selected period of time until such time that sell transaction is justified.

In the case of the Company being unable to net off the shares of the mutual fund to be sold, the Company will identify whether the mutual fund holds a cash element 332. Where this is the case the Company will net off shares in the fund directly with cash element 340 of the fund deducting fees 341 in the process. If all shares of the mutual fund can be sold in this way the process is complete and the appropriate funds are credited to the consumer's account 352. If there are shares in the fund remaining, the Company will retain these shares and determine, as with the equity sale 336, whether the collective value justifies a transaction 344. If this is the case the transaction is made by the company to sell the shares 350, a fee is extracted 351, and the funds are allocated to the consumer accounts 352. Where the value does not enable cost effective selling of the shares the shares of the fund are retained 346 and 326 until such time that they are added to or can be netted off.

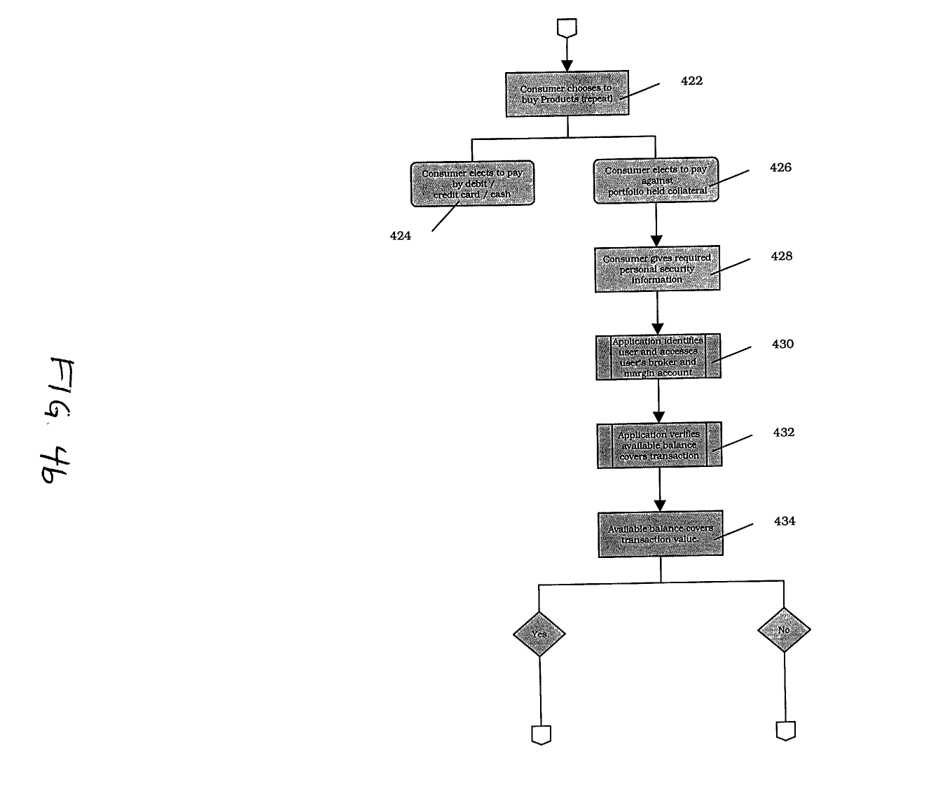

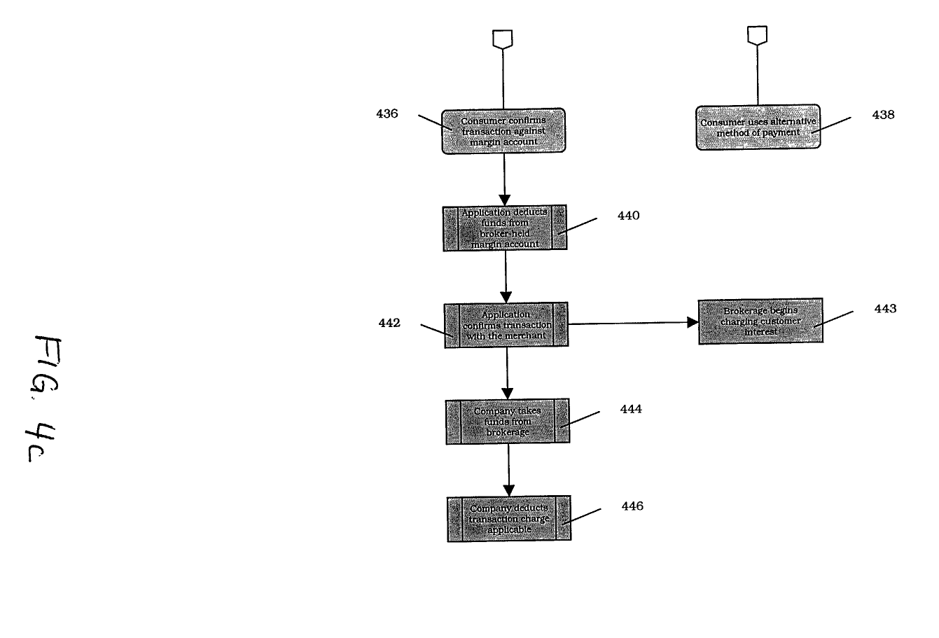

Referring to FIGS. 4a-4c, which illustrate the Margin Flow of Merchants where the consumer purchases from a Merchant, a Supplier, Retailer or Sales Intermediary, or any provider of goods and services in an alternative preferred embodiment against portfolio-held collateral (margin accounts) for low cost secured credit. The Company enters into agreements with brokerages governing the ability of their clients to get remote access into their portfolios 410, i.e., access their portfolios from sources other than the brokerage itself. The agreements enable the Company to adopt the brokerages access security methods into an application that enables consumers to access their accounts, check the available balance of margin accounts where they exist and make transactions directly affecting the balance of these accounts 412. With the brokerage agreements in place, the company enters into agreements with Merchants licensing access to the application (and rights inferred) from the Company's agreements with the brokerages 414, whereby the Merchants are able to incorporate the company application facilitating purchases against margin accounts into their own transaction process 416. The Merchants are then able to promote their products for sale providing the consumers the additional ability to make purchase against margin as opposed to cash, debit or credit facilities 418. A consumer visiting the merchant 420 and making a purchase 422 is presented with a choice to pay either by the usual cash, bank or credit card 424 or by margin 426. In the event the consumer has a margin account with a brokerage partnered by the Company and thereby included in the transaction application, the consumer inputs personal security information 428 such that the application is able to identify the consumer, access the consumers brokerage account (specifically) the consumer's margin account 430 and verify that the available balance in the margin account is sufficient to cover the value of the Product(s) purchased. 432. If the available balance is sufficient, the Consumer provides confirmation of the transaction 436 and the funds are immediately deducted from the Consumer's margin account 440. Funds are deducted from the available margin balance before confirmation of the transaction is passed to the merchant to ensure the brokerage is protected against multiple transactions against the same account at the same time. The Merchant is then provided with confirmation of transaction completion 442 and is able to issue receipt and the Product(s). From this point on, according to the terms agreed between the consumer and its brokerage the brokerage begins charging interest on the outstanding balance of the margin account 443. With the transaction complete, the company will be paid by the brokerage the funds equivalent to the value of the transaction 444, the company will deduct any transaction fees agreed with the merchant in the aforementioned agreements 446 and pass on the balance to the Merchant.

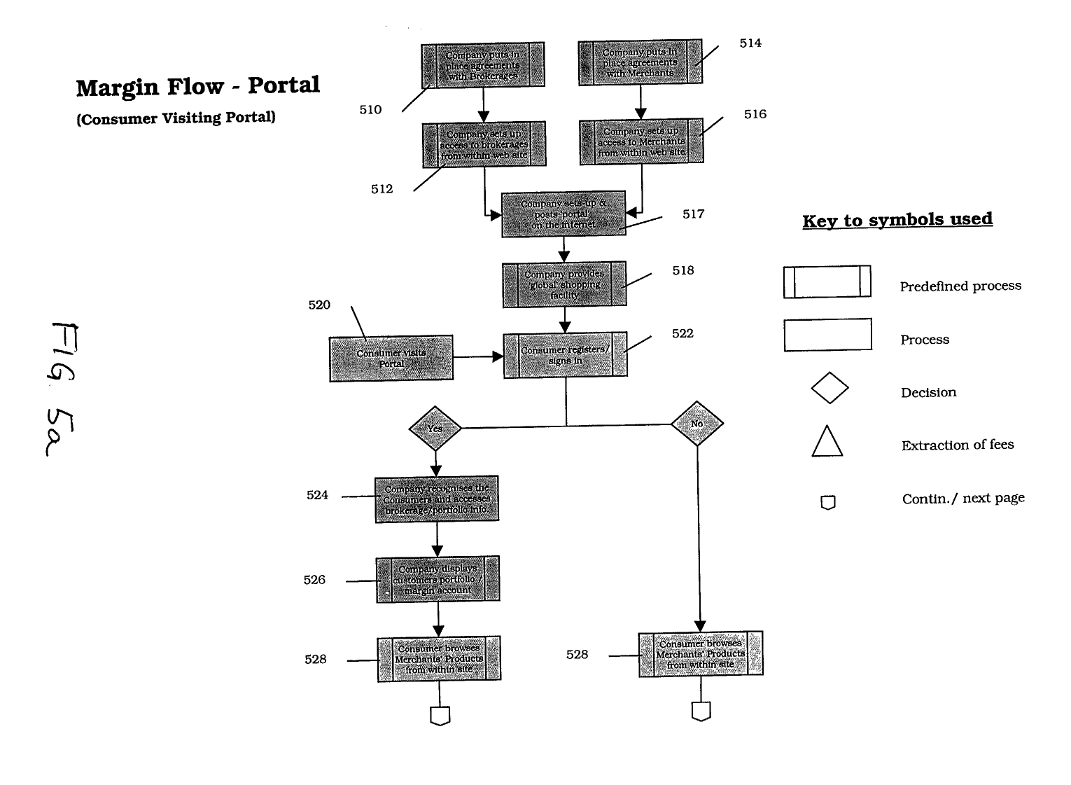

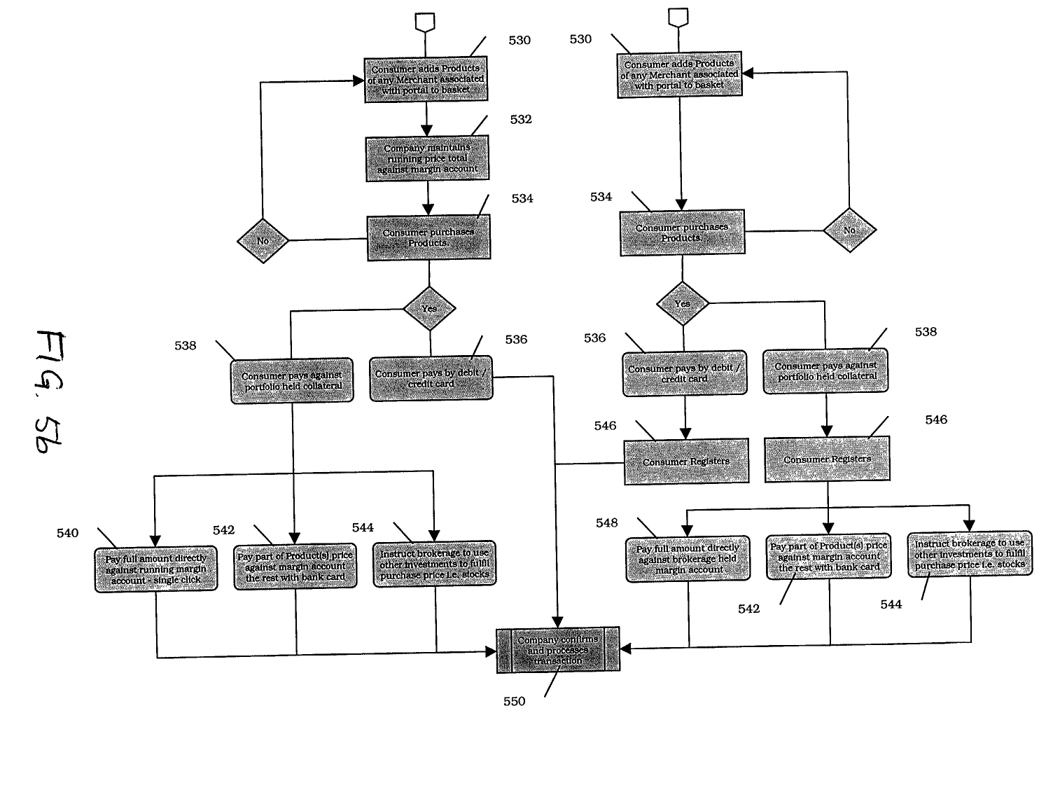

Referring to FIGS. 5a and 5b, the Margin Flow process of a consumer visiting a portal is illustrated as an alternative preferred embodiment. The primary purpose of the portal is to enable the purchase of Products from multiple online Merchants using the portfolio held investments as collateral for low cost secured debt. The design of the web site will allow a consumer to visit the portal, view their brokerage held margin account(s), browse online Merchants from within the portal and to give consumers the ability to spend the margin balance directly on the merchant's Products.

As illustrated in FIG. 5A, the Company has agreements with various brokerages 510 which allow consumers to access the brokerage from within the portal such that consumers can register to set up accounts with them. The consumer's portfolios are held by the brokerages. Access to the brokerages is through the Company web site 512. The agreements allow the consumer to make transactions affecting the margin availability of the portfolio. As set forth above, the advantages of this system is that brokerages can provide additional services to its customer base and encourage customers to borrow against their investment portfolio which generates revenue for the brokerage.

In addition to the brokerage agreements 510, the company also has agreements with on-line Merchants 514, such that they are able to sell and/or promote their products through the portal 516. In setting up the portal 517 and providing a single ‘global’ shopping basket 518, the Company supports the channeling of the prospective online shoppers to the site and provides a service that allows these consumers to make purchases against collateral, held in a portfolio with a brokerage, without leaving the Company's web site. The global shopping basket 518 enables the consumers to place Products from any of the associated merchants in the portal. The basket will display a running total of all products such that they can be purchased in one transaction whether against a margin account or credit/debit card. The design of the web site aids the Company in providing links to other Company services and advertisers. All information on the associated Merchants will be accessed by those visiting the portal from within the portal web site itself, as explained in greater detail below.

Referring to FIG. 5a, when a registered user visits the portal 520 and signs in 522, the Company will recognize the Consumer if they hold portfolios with a brokerage 524 and will provide a link to the brokerage and automatically retrieve and upload pertinent information regarding the Consumers portfolio 526 such that they are made aware of the extent of their ability to purchase Products against margin. It is envisaged that not only will a consumer be able to purchase against a margin account, but that from the portal they could also instruct their brokerage to sell enough of a stock to cover a single/or series of purchases from the portal. The primary purpose of the portal, however, is to enable the purchase of Products from multiple online “merchants” (i.e., manufacturers/distributors/retailers, etc.) using the portfolio held investments as collateral for low cost secured debt.

Consumers can choose to register 522 with the portal upon visiting the portal 520. When they register, information taken will include details of their portfolio accounts held with the aforementioned brokerage partners. This information will, under the prior brokerage agreements, enable the registered consumer to view the status of their brokerage held portfolio from within the site. The importance being that the consumers are able to see their margin account balance (or balances according to how many portfolios they hold with different brokerages) facilitating efficient purchase of Products against margin.

Regardless of whether the Consumer registers with the portal, the Consumer can browse through the Product(s) 528 of the merchants linked to the site from within the domain of the portal and add Products to its shopping cart 530. When a Consumer visits the portal and browses the products of the merchants liked to the site, they will do so from within the domain of the portal. Shopping from within the domain of the portal enables the display of available margin and the single shopping basket at all times 532. This allows a Consumer to buy goods from multiple merchants in a single session on the Internet with only making one financial transaction. Having selected all the Products the Consumer wishes to purchase and having placed them in the global shopping basket, the Consumer is able to commit to the purchase. If the Consumer has registered with the Company 522, the Company maintains a running price total against the margin account 532. When the Consumer wishes to purchase a Product(s), the Consumer has the option of paying by debit/credit card 536 or paying against the portfolio held collateral 538. If the Consumer has not registered with the Company before browsing the Products, upon making a purchase 534, the Consumer must register with the Company 546.

The price of the Product can be paid in several ways. For example, the Customer can pay the full amount directly against a running margin account 540. Alternatively, the Consumer can pay part of the Product price against a margin account and the remainder of the amount by debit/credit card 542. Yet another option is to instruct the brokerage to use other investments to fulfill the purchase price 544, for example, with stocks. Regardless of which option is selected, the Company thereafter confirms and processes the transaction 550 by informing those parties from whom the Products have been purchased and the brokerage from whom the margin account is held. At this point the retailers/manufacturers will ship the Products and the brokerage will begin charging the customer the relevant interest on the used margin etc.

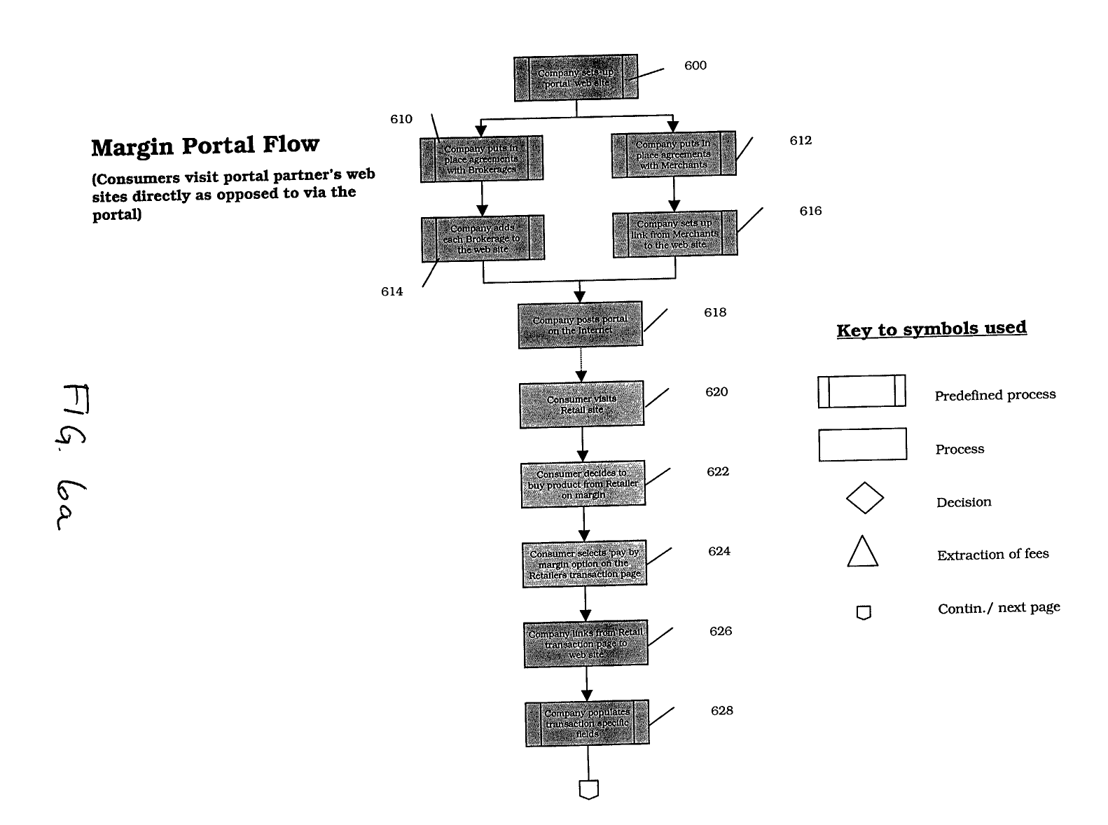

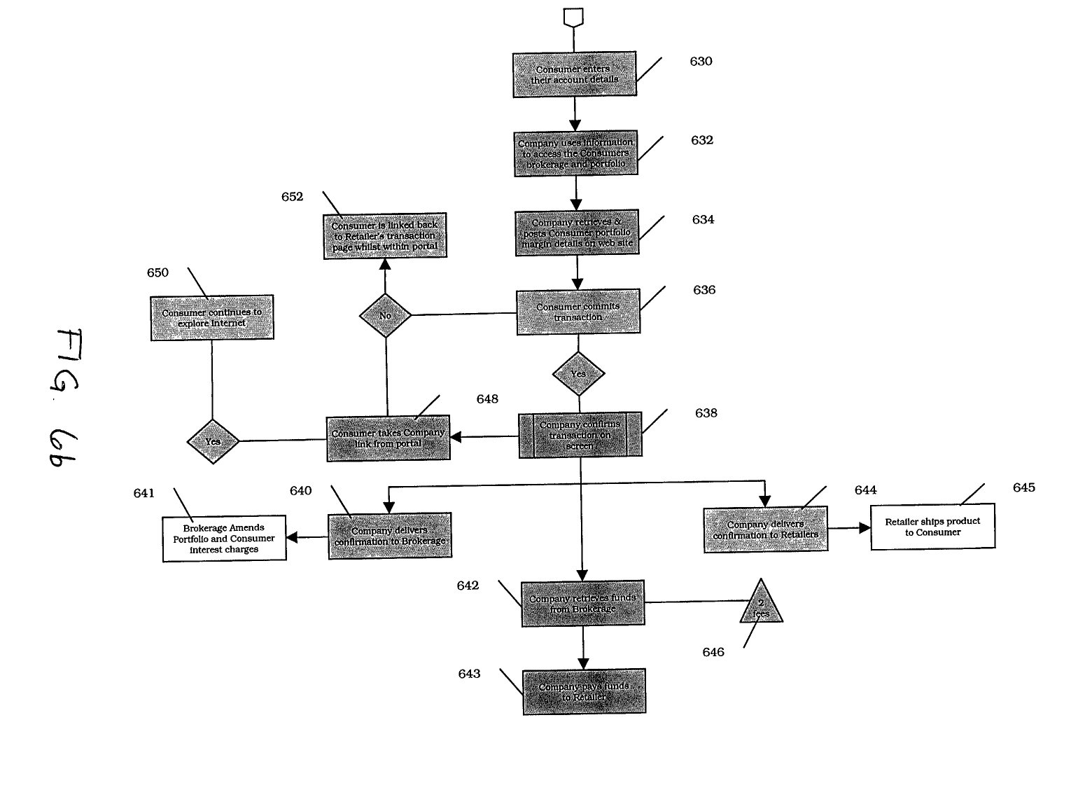

Referring now to FIGS. 6a and 6b the Margin Flow-Portal alternative preferred embodiment of the invention is illustrated. In this embodiment, the Consumer visits the Portal Partner's web site directly, instead of through the portal, to make transactions that affect the margin availability of the portfolio. The portal web site is set up by the Company 600. In setting up the web site the Company supports the channeling of prospective online shoppers to the site and provides a service that allows these customers to make purchases against collateral (held in a portfolio with a brokerage) without leaving the Company's web site. The minimum that is required are fields for transaction details such as product specifics, price, delivery address, customer, portfolio value, available margin, interest to be charged by brokerage, fees for transaction, etc.

As with the previous embodiments, the Company has agreements with brokerages 610 and merchants 612. The agreements allow consumers to access their portfolios held with the Brokerage from the Company's web site and allow the consumer to make transactions that affect the margin availability of the portfolio. This enables the Brokerages to provide greater service to its customer base and encourage customers to borrow against their investment portfolio and therefore generate revenue. The agreements specify that the merchant's transaction page provide a “pay by margin” option that links the Consumer to the Company's web site. Access to the brokerages 614 is through the web site. Each brokerage partnering the site will be available for access by the consumer from within the portal such that consumers can register and set up accounts with them. Behind this the brokerages will be linked directly to the retail site such that when a registered users signs on, the Company can automatically retrieve the portfolio investment information relating to the particular customer.

The merchants 616 have links from the merchant's site to the Company web site, which will facilitate the return link after the consumer has committed or cancelled the margin transaction. This link will automatically populate the relevant fields of the Company web site with details such as Consumer name, delivery address, Product, specifics, Price, etc. As the Company has previously set up a portal web site 600, the Company now posts the portal on the Internet 618. Upon visiting a retail site 620, a consumer decides to buy a product from a retailer on margin 622, and selects “pay by margin” option on the retailer's transaction web page 624. Thereafter, the Company links from the retail transaction page to the web site 626 where the Consumer can quickly and efficiently complete the transaction against margin held in a portfolio with one of the brokerages. This enables the retailer to service its customer better, and makes the purchase of products easier, while reducing transaction costs and promoting their site through portal publicity.

The Company populates transaction specific fields 628 such as product specifics, price, delivery address, customer portfolio value available margin, interested to be charged by the Brokerage and Fees for the transaction, for example. The Consumer enters account details 630. With the consumer's account information, the Company accesses the Consumer's brokerage and portfolio held by the brokerage 632. The Company then retrieves and posts the Consumer's portfolio margin details on the web site 634.

When a consumer commits to a margin transaction 636, the transaction is confirmed on a display screen or computer monitor 638 such that the Consumer has a printable record or at the very least is notified that the transaction has been accepted. The Consumer will then have the choice of returning to the web site from which they came (but still within the portal) or investigating one of the Company's provided links. Prior to this, the Company will first check that the Consumer's available margin covers the transaction value. The company then delivers confirmation of the transaction to the brokerage 640 also who amends the portfolio and consumer interest charges 641. The Company also retrieves funds from the brokerage 642, pays funds to the retailer 643, and delivers a confirmation to the retailers 644, whereupon the retailer ships the product to the Consumer 645. In retrieving funds from the brokerage, fees are extracted 646 by the Company. The Consumer has the further option to take the company link from the portal 648 and continue to explore the Internet 650. If the Consumer does not commit to a transaction, the Consumer is linked back to the retailer's transaction page while within the portal 652.

The Company extracts fees from three (3) sources. The Brokerages and Retailers are charged by the Company for enabling them to provide the service to their customers and having the opportunity to generate greater revenue for themselves, and finally from the Consumers who will pay a small per transaction fee for the privilege of being able to efficiently purchase against their investment collateral.

Numerous modifications are intended to be included within the scope of the invention as defined in the appended claims without departing from the spirit and scope of the invention. It is intended that the invention shall cover by suitable expression in the appended claims whatever features of patentable novelty exist in the invention disclosed.

What is claimed is:

1. A method of providing a consumer of products with equity in the provider of said products, comprising the steps of:
selecting a product of the provider offered for sale;
determining a percentage based on the cost of the product to be rewarded to a consumer in the form of equity in the provider;
charging the consumer for the cost of the product;
retaining the percentage for a selected period of time for funding the purchase of equity associated with said provider;
acquiring equity in said provider; and
transferring the acquired equity into the consumer's brokerage account.

2. The method of claim 1, further comprising the step of: accumulating additional percentages for a selected period of time for funding the purchase of equity associated with the provider.

3. The method of claim 1, further comprising the step of: providing the consumer with a brokerage account.

4. The method of claim 1, wherein equity includes equity options and mutual funds.

5. The method of claim 1, wherein the consumer pays for the product against margin through the consumer's brokerage account includes portfolio-held collateral.

6. The method of claim 1, further comprising the step of: providing the consumer with the option of adding additional amounts to said percentage.

7. The method of claim 1, further comprising the step of: netting off demand for equity with consumers selling equity associated with the same provider of products.

8. The method of claim 1, further comprising the step of providing the consumer with the option of selling investments.

9. The method of claim 1, wherein the product includes goods and services.

10. A method of providing a consumer with the ability to purchase products directly through a company's portal or web site against a consumer's margin accounts, comprising the steps of:
entering into a first agreement for a selected period of time with a brokerage, wherein consumers are able to access the consumer's portfolio through a company's portal or web site through which the consumer makes transactions affecting the margin availability of a consumer's margin account;
entering into a second agreement for a selected period of time with a provider to offer for sale the provider's products on the company's portal or web site whereby a consumer selectively purchases a product against the consumer's margin account through the company's portal or web site; and
processing the purchase transaction made by the consumer.

11. The method of claim 10, the step of processing further comprising the steps of:
notifying the brokerage and the providers of the completed transaction;
retrieving funds from the brokerage;
extracting a transaction fee; and
distributing the funds to the providers.

12. The method of claim 10, further comprising the step of: providing an equity reward in the provider associated with the product purchased by the consumer.

13. The method of claim 12, further comprising the steps of: retaining a percentage based on the cost of the product purchased for a selected period of time for funding the purchase of equity associated with the provider.

14. The method of claim 13, further comprising the step of: accumulating additional margin percentages for a selected period of time for funding the purchase of equity associated with the provider.

15. The method of claim 10, wherein equity includes equity options and mutual funds.

16. The method of claim 13, further comprising the step of: providing the consumer with the option of adding additional amounts to said margin percentage.

17. A method providing a consumer with the ability to make transactions affecting the margin availability of the consumer's portfolio-held collateral through a portal, comprising the steps of:
entering into an agreement with a brokerage allowing a company to provide an application enabling a consumer to make a transaction affecting the margin availability of portfolio-held investments wherein the brokerage is directly linked to a provider's web site;
entering into an agreement with a plurality of providers that specifies a margin percentage with which the provider will reward the consumer with equity in the provider of a product for the purchase of the product, and that provides a pay-by-margin option that links the consumer to the company web site, and wherein the providers have direct links to the company web site; and
processing a transaction affecting the consumer's margin availability upon a consumer making a purchase.

18. The method of claim 17, the step of processing further comprising the steps of:
confirming a consumer's committed purchase against the available margin,
delivering confirmation of the transaction to the brokerage;
retrieving funds from the brokerage;
extracting fees from the brokerage;
paying funds to the provider; and
delivering confirmation of the transaction to the provider.

19. The method of claim 17, wherein equity includes equity options and mutual funds.

20. The method of claim 17, further comprising the step of: retaining a margin percentage based on the cost of the product purchased for a selected period of time for funding the purchase of equity associated with the provider.

21. A method of purchasing of products from a supplier against margin, comprising;
entering into an agreement for a selected period of time with a brokerage, wherein a supplier enables a consumer with the ability to purchase a product of the supplier of goods against a consumer's margin account held by the brokerage;
charging the consumer for the cost of the product.
